(19) United States
(12) Patent Application Publication
(10) Pub. No.: US 2026/0049042 A1
(43) Pub. Date: Feb. 19, 2026

(54) METHOD OF USING THERMALLY HYDROLIZED FEATHER KERATIN HYDROLYSATE PEPTIDES (KHP) IN PROTECTING PLANTS AGAINST ACIDITY STRESS

(71) Applicant: CH Biotech R&D Co., Ltd., Nantou City (TW)

(72) Inventors: Nai-Hua YE, Changhua (TW); Kai XIA, Nantou (TW); Ming-Yuan LEE, Nantou (TW); Ming-Ru LIOU, Taichung (TW); Gui-Jun LI, Taichung (TW); Cheng-Hui TSAI, Yunlin County (TW); Huan-Hsuan LIANG, Taichung (TW)

(73) Assignee: CH Biotech R&D Co., Ltd., Nantou City (TW)

(21) Appl. No.: 18/902,317

(22) Filed: Sep. 30, 2024

(30) Foreign Application Priority Data
Aug. 15, 2024 (TW) 113130757

(51) Int. Cl. C05F 1/00; C05C 11/00

(52) U.S. Cl. CPC C05F 1/005; C05C 11/00

(57) ABSTRACT

Present invention teaches the method of using a keratin hydrolysis peptide (“KHP”) solution to improve the growth of various farming plants exposed to acidity stress by selectively choosing specific weights of feathers and water, and treating the mixture to a high-temperature high-pressure hydrolysis process, the resulting solution is confirmed to contain at least 253 peptides and then infused to the soil or other growth medium. Optionally, the KHP solution can be diluted by water, as disclosed in the specification, for applying to the soil or other growth medium.

### PRIORITY CLAIM TO FOREIGN APPLICATION

Applicant hereby makes priority claim to a Taiwan application, number 113130757, having the Taiwan filing date of Aug. 15, 2024.

### SEQUENCE LISTING

Table I (in Sequence Listing XML format) shows the at least 253 peptides and its annotated sequences for the solution generated in accordance with the disclosure of this application. The Sequence Listing XML file complies with the WIPO ST.26 requirements. Said XML copy, created on Mar. 17, 2024, is named Table-I-253_sequence and is 216 bytes in size.

Applicant hereby incorporated by reference said Sequence Listing XML file in its entirety as part of the disclosure and specification of the present application.

### BACKGROUND OF THE INVENTION

Present invention disclosed and claimed the method and application of a keratin hydrolysis peptide (“KHP”) as a biostimulant to plants growing in acidic environment.

The KHP solution works to mitigate the inhibition upon plants under acid tress, and increase the above-ground biomass including fresh weight, leaf surface area, chlorophyll count, carotenoids and nitrate content of the plant, and promote root development to improve the overall nutrient intake.

Soil acidification refers to a soil environment where the pH value is lower than 5.5. Globally, over half of all farming land shows signs of soil acidification, which leads to lower nutrient and water intake efficiency of plants.

For certain plants, some toxicity comes from higher concentration of hydrogen ions, resulting in higher solubility of Iron (Fe), Manganese (Mn), Aluminum (Al) and other similar metallic ions that are toxic and would interfere with the plaints' absorption of Calcium (Ca), Magnesium (Mg), Potassium (K) and Molybdenum (Mo), all of which contribute to the plants' growth and development. (Borhannuddin Bhuyan et al., Plant Abiotic Stress Tolerance: Agronomic, Molecular and Biotechnological Approaches, 35-82, 2019; Chen et al., Communications in soil science and plant analysis 43(13: 1833-1846, 2012).

The ever-increasing soil acidification brought about more challenges that went beyond the capacity of known varieties of acidity-tolerance mechanism evolved by plants to cope with the acidity stress.

The keratin solution is primarily based upon feather, which contains 85-91% keratin, 13-15% organic nitrogen, 1.6-2% organic sulfur, as well as other materials. The high keratin content has drawn many prior researches that work to break down, by enzyme, chemical agents, or fermentation process, into peptides, amino acids and other smaller molecules that can be used for animal feeds, plant fertilizers, and cultivation bases.

Around 2019, Nurdiawati, et al, came up with a hydrolysis process, by the mixture of α-amylase and protease to hydrolyze feather waste, resulting in a mixture of amino acids, fatty acids, and sugars. Nurdiawati experimented and adopted certain specific high-temperature and high-pressure setting in the hydrolysis process and discovered that the resulting solution, when mixed with some potassium and other minerals, can boost the growth of Pogostemon cablin and Vigna radiata, as reported in International Journal of Recycling or Organic Waste in Agriculture (8:221-232, 2019).

Hydrolyzed keratin has long been used to strengthen hairs, reduce hair splitting and breakage. Other beneficial uses include skin moisturization and wound healing. Keratin hydrolysate has also been known to function as a biofertilizer, boosting plants' growth by enhancing the plants' ability to receive and utilize nutrients, including commonly applied fertilizers.

The KHP solution is made by a hydrolysis process using feathers and water, via a high-temperature and high-pressure process, resulting in a solution that has many beneficial applications in the fields of horticulture, agriculture and potentially other farming businesses.

Among the embodiments disclosed and claimed in this application, one specific embodiment used feathers only, without water, to be treated with the high-temperature and high-pressure process as taught herein to produce a specific version of the KHP

### Solution

The inventors of present application conducted numerous tests and confirmed the effectiveness of applying the KHP solution as disclosed herein to enhance the plants' ability to cope of the stress caused by soil acidification.

### SUMMARY OF THE INVENTION

The inventors of present application, under the aegis of CH Biotech, developed and selected different feather and water compositions to perform the hydrolysis at higher temperature and higher pressure setting, resulting with different keratin hydrolysis peptide (“KHP”) solution that can be used on different crops/plants.

The selected embodiment of present invention uses a mixture of water and feathers, and subject the mixture to a thermal hydrolysis process to create KHP solutions based upon temperature/pressure parameters as noted below.

The KHP solutions can be applied to water-based solution for growing farm plants, or applied to the soil containing farming plant. The various experiments show that the plants are able to withstand soil acidification stress and even attain nutrient intake level of normal growth and development when plants were not under acidity stress.

The inventors used the Dionex UltiMate 3000 UPLC to separate the peptides; an analysis is done via Thermo Orbitrap Fusion Lumos Tribrid Orbitrap mass spectrometry to identify the peptides, which are then subsequently confirmed by looking up the BIOPEP-UWM database.

The solution can be diluted by water, at 50 to 2,000 ratio by volume.

### BRIEF DESCRIPTION OF DRAWINGS

The accompanying drawings, figures and tables, which are incorporated in and constitute a part of this specification, illustrate and exemplify the preferred embodiments of the invention. Together with the description, serve to explain the principles of the invention.

FIGS. 1A, 1B and 1C compared the CK group's and KHP group's above-ground length, root length and whole plant fresh weight per inventors' tests on Tsui-mei lettuce.

FIGS. 2A, 2B and 2C compared the CK group's and KHP group's above-ground length, root length and whole plant fresh weight per inventors' tests on Lady tomato.

FIGS. 3A and 3B compared the CK group's and KHP group's above-ground and underground biomass fresh weights per inventors' tests on young corn plants.

FIGS. 4A and 4B compared the CK group's and KHP group's above-ground and underground biomass fresh weights per inventors' tests on young soybean plants.

FIGS. 5A and 5B compared the CK group's and KHP group's above-ground and underground biomass fresh weights per inventors' tests on young rice plants.

FIGS. 6A, 6B and 6C compared the CK group's and KHP group's above-ground weights, plant heights and leaf area sizes per inventors' tests on Tsui-mei lettuce.

FIGS. 7A, 7B and 7C compared the CK group's and KHP group's above-ground weights, plant heights and leaf area sizes per inventors' tests on Lady tomato.

FIGS. 8A, 8B, 8C and 8D compared the CK group's and KHP group's measured amounts of photosynthetic pigments per the inventors' tests on Tsui-mei lettuce on the fifth day after KHP solution's application.

FIGS. 9A, 9B, 9C and 9D compared the CK group's and KHP group's measured amounts of photosynthetic pigments per the inventors' tests on Lady tomato on the fifth day after KHP solution's application.

FIGS. 10A, 10B, 10C and 10D compared the CK group's and KHP group's measured amounts of photosynthetic pigments per the inventors' tests on young corn plants on the third day after KHP solution's application.

FIGS. 11A, 111B, 11C and 11D compared the CK group's and KHP group's measured amounts of photosynthetic pigments per the inventors' tests on young soybean plants on the third day after KHP solution's application.

FIG. 12 compared the amount of nitrate content on the fifth (5^{th}) day between the CK group and KHP group.

### DETAILED DESCRIPTION OF THE INVENTION

The keratin hydrolysis peptide (“KHP”) solution of present invention is made by a high-temperature and high-pressure process to treat a mixture of water and feathers as shown in the parameters herein.

The mixture ratio, temperature, pressure and duration parameters are shown herein:

| | | | Water content | | | | | |
|---|---|---|---|---|---|---|---|---|
| | Feather | Water | in feather | Pressure | Temp. | Time | Mass | Concen. |
| KHP # | (kg) | (kg) | (%) | (kg/cm²) | (° C.) | (min) | (Da) | (ppm) |
| KHP-1 | 66 | 44 | 50% | 16 | 195 | 40 | 593.3~3823.0 | 200000 |
| KHP-2 | 70 | 0 | 46% | 13 | 180 | 40 | 705.9~3194.7 | 381250 |

The hydrolysis process in the first embodiment takes the steps of:
a. Preparing the KHP solution by mixing 66 kg of feathers whose content is 50% water with 44 kg of water in a sealed container;
b. hydrolyzing the mixture in the container with a temperature and pressure setting of 195° C. and 16 kg/cm² for a duration of 40 minutes;
c. using a mass spectrometer to confirm the combination of peptides in the solution to contain at least 253 peptides as listed in the specification where their molecular masses are between 500 and 4,000 Daltons, and the concentration is in the range of 2.0×10⁵˜4.5×10⁵ ppm.

The keratin hydrolysis peptide (KHP) solution of the first embodiment is further filtered and concentrated to 200,000 ppm concentration.

A second embodiment of keratin hydrolysis peptide (KHP) solution, without water, can be made by 70 kg of feathers, with the feathers' water content being 46%, and then treated by the steps of:
a. stirring the feathers in a sealed container;
b. hydrolyzing the feathers in the container with a temperature and pressure setting of 180° C. and 13 kg/cm² for a duration of 40 minutes;
c. using a mass spectrometer to confirm the combination of peptides in the solution to contain at least 253 peptides as listed in the specification whereby their molecular masses are between 705.9 and 3,194.7 Dalton, and the concentration is in the range of 2.0×10⁵˜4.5×10⁵ ppm.

The keratin hydrolysis peptide (KHP) solution of the second embodiment is further filtered and concentrated to 381,250 ppm concentration.

The confirmation of some of the 253 peptides is further done by referencing the BIOPEP-UWM database.

To test the effectiveness of the method disclosed herein to reduce the negative impact of acidity stress, the inventors found out that applying the KHP solution to the farming plants, either grown in water-based solution or in soil, increased the above-ground fresh weight and height, boosted chlorophyll and carotenoid counts and strengthened the roots' ability for nutrient intake.

The inventors selected the above KHP-1 solution (“KHP” for short) to conduct various tests as stated herein. For applying into water-based farming plant cultivation, the concentration is set at between 0.001 ml/L and 0.10 ml/L. For applying to the soil where farming plants are grown, the dilution ratio, diluted in water by volume, is between 1:50-2,000 (noted as 50×-2,000×), with a narrower preferred range of between 100×-1,000×.

Several farming plants are selected for the experiments and tests herein. These plants are cultivated in acid environment (either solution or soil) for testing; these plants are designated as Check group (noted as CK group). Another group of plants are being remedied by the method of KHP solution application (noted as KHP group) as disclosed herein.

The inventors selected Tsui-Mei lettuce and Lady Tomato for testing the adversity of acidity stress, and for comparison to the group with such stress alleviated by the application of KHP solutions.

Water-based solution is first made by distilled water added with MS (Murashige and Skoog) and Hoagland powder, forming a cultivation solution. Using selected amount of HCl and NaOH, creating growth environment of pH 6 (normal) and pH4 (acid).

KHP solution is diluted in the range of 0.01 ml/L and 0.05 ml/L, and infused into the cultivation solution.

The inventors put seedlings of lettuce and tomato into containers with the cultivation solution, placed in growth chambers with temperature set at 27° C., for three days. The plants are divided into two groups: Check (CK) group plants are grown in acid environment, whereas KHP group plants are added with the KHP solution.

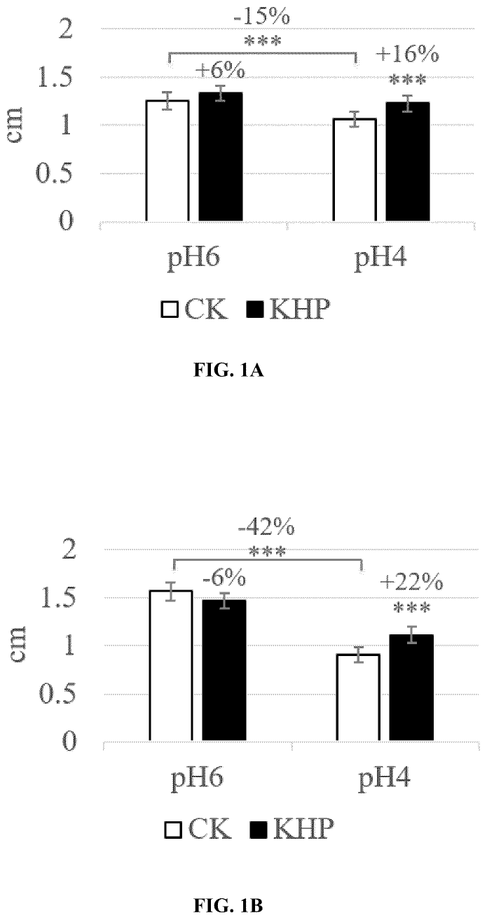

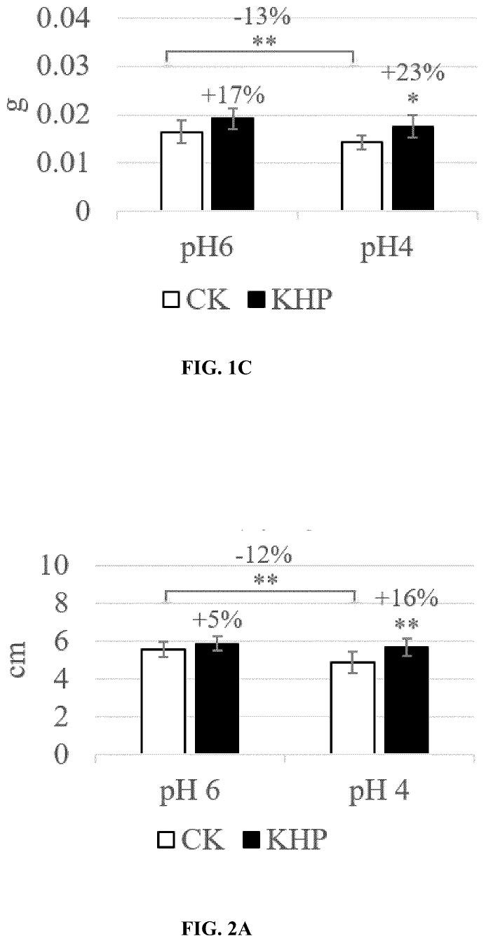

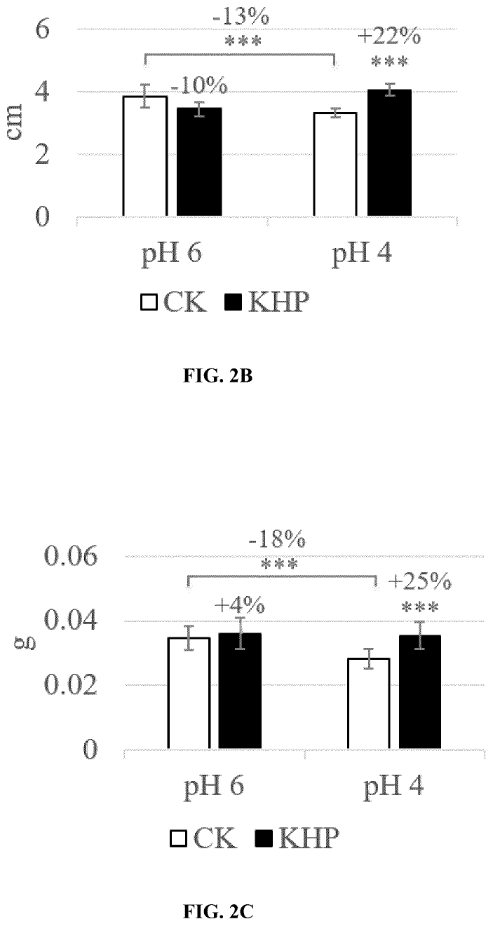

As observed and noted in FIGS. 1 and 2, for lettuce and tomato plants, relative to the normal acidity of pH6, the CHK group plants in the pH4 environment show severe signs of stunted growth. Whereas the KHP group plants, with 0.05 ml/L addition of KHP solution, the acidity stress symptoms are greatly alleviated.

For the Tsui-mei lettuce plants, the above-ground lengths, root lengths and whole plant fresh weights increase by 16%, 22% and 23%, as reflected in FIGS. 1A, 1B and 1C.

FIG. 1A shows, at different acidity pH values, the above-ground lengths between the two groups. FIG. 1B shows the root length between the two groups. FIG. 1C shows the whole plant's fresh weight between the two groups. The KHP group was infused with the KHP solution at the concentration of 0.05 ml/L.

As can be seen in the three figures, with higher acidity, the lettuce experienced worse growth. With the application of the KHP solution, the overall growth and health are restored and the injury from the acidity is well mitigated.

The inventors tested the acidity stress on Lady Tomato plants in a water-solution cultivation environment, for three days. For the KHP group, the cultivation solution as added with 0.01 ml/L KHP solution. Substantial improvement is shown relative to the CK group where the tomato plants are exposed to pH4 acidity stress.

FIG. 2A shows, at different acidity pH values, the lengths of the CK group and the KHP group. FIG. 2B shows the root lengths between the two groups. FIG. 2C shows the whole tomato plant's fresh weight. The increases, noted in FIGS. 2A, 2B and 2C are 16%, 22% and 25% respectively.

The inventors further tested the effectiveness of KHP solution to combat the acidity stress with additional farming plants of corn, rice and soybean.

The corn (Zea mays) species of Hua-Jen is selected by the inventors for testing. The corn seeds are first placed in centrifuge tubes, using 2.5% sodium hypochlorite to sterilize for 5 minutes, and cleaned with RO water 5 times. The corn seeds are then set in a cultivation disks with 15 ml RO water, placed in a growth chamber for 2 days, at 27° C. temperature, to urge the initial germination.

The soybean (Glycine max) species of Kaohsiung No. 10 is selected by the inventors for testing. The soybean seeds ae set in a cultivation disk with 15 ml of RO water, placed in a growth chamber for 2 days, at 27° C., to urge the initial germination.

The rice (Oryza sativa) species of Tai-Nun No. 67 is selected by the inventors for testing. The rice seeds are placed in centrifuge tubes, using 1% sodium hypochlorite to sterilize for 5 minutes, and cleaned by RO water 5 times. The seeds are then set in a cultivation disk, placed in a growth chamber for 3 days, at 27° C., to urge the initial germination.

The inventors used solutions comprised of HCl and NaOH to concoct fluids with acidity values of pH6 (normal) and pH5/pH4. The KHP solution so made pursuant to the disclosure herein is diluted 2,000× (final concentration is 0.05 ml/L). The inventors then use 500 ml acid solutions to the CK group plants (soybean, rice and corn), while the KHP group plants are added with the KHP solution. After a few days, some measurements are taken and tabulated into figures as further noted.

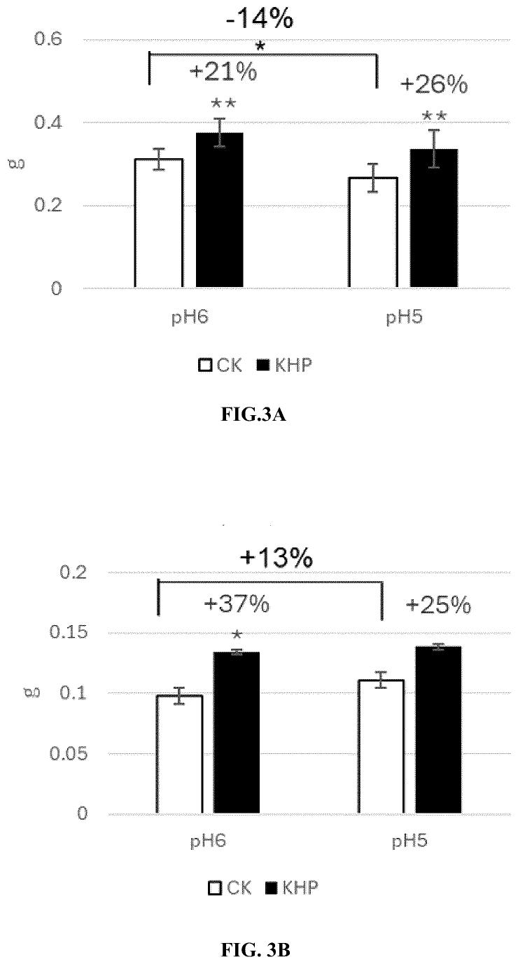

For the corn plants tested, FIG. 3A shows, at different acidity pH values, the above-ground biomass fresh weights of the CK group and the KHP group. FIG. 3B shows the underground biomass fresh weights of the two groups. The KHP group is infused with KHP solution at concentration of 0.05 ml/L.

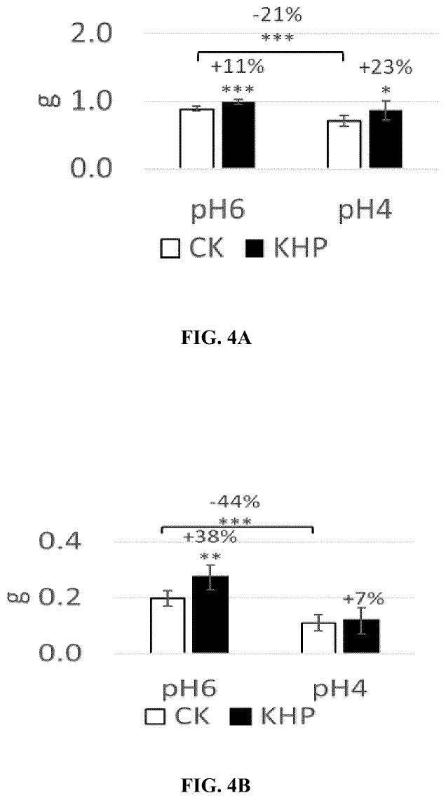

The inventors tested the acidity stress on a young soybean plant in a water-solution cultivation environment, for three days. FIG. 4A shows, at different acidity pH values, the above-ground biomass fresh weights of the CK group and the KHP group. FIG. 4B shows the underground biomass fresh weights of the two groups. The KHP group is infused with KHP solution at concentration of 0.05 ml/L.

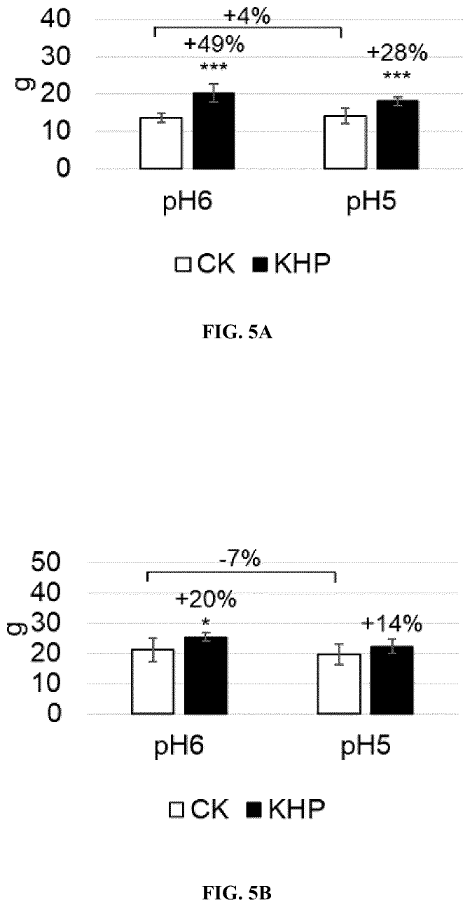

The inventors tested the acidity stress on a young rice plant in a water-solution cultivation environment, for three days. FIG. 5A shows, at different acidity pH values, the above-ground biomass fresh weights of the CK group and the KHP group. FIG. 5B shows the underground biomass fresh weights of the two groups. The KHP group is infused with KHP solution at concentration of 0.05 ml/L.

As reflected in FIGS. 3-5, the infusion of KHP solution to the plants (corn, soybean and rice) that are under acidity stress, the corn plants increased above-ground and underground weights by 26% and 25% (FIGS. 3A and 3B); the soybean plants creased above-ground and underground weights by 23% and 7% (FIGS. 4A and 4B); the rice plants increased above-ground and underground weights by 28% and 14% (FIGS. 5A and 5B).

The inventors further tested the KHP solution's help to plants grown in acid soil by analyzing the lettuce and tomato growth condition in soil with acidity value of pH5. The inventors chose some acidic soil collected from fields for the plants in the Check (CK) group; another group is added with KHP solution diluted at 1,000×. Subsequent observations and measurements were taken and recorded.

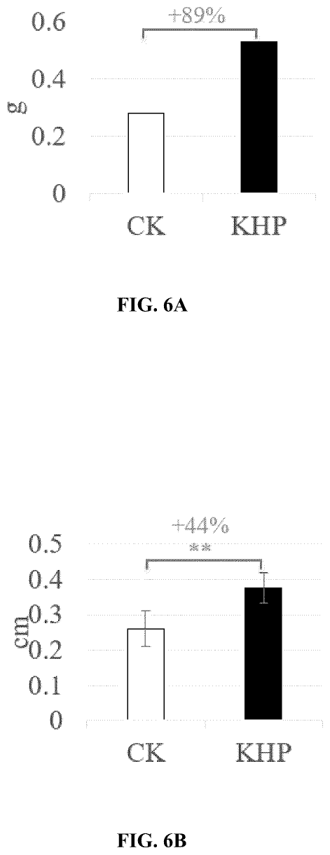

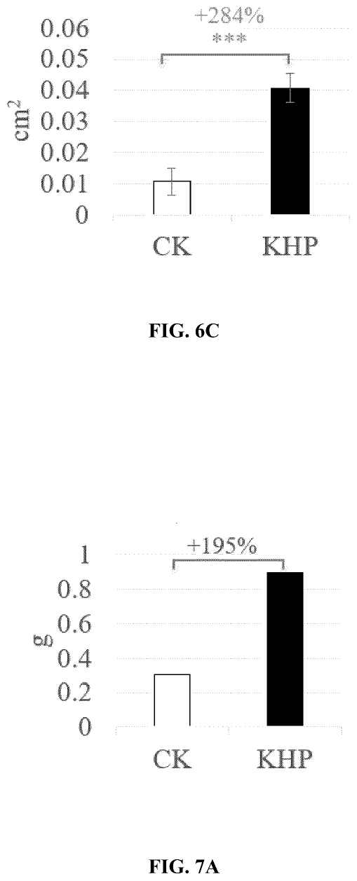

For the Tsui-mei lettuce tested above, on the fifth (5^{th}) day after the KHP solution's application, the comparisons are noted. FIG. 6A shows the above-ground fresh weights; FIG. 6B shows the plant heights; FIG. 6C shows the leaf surface area sizes.

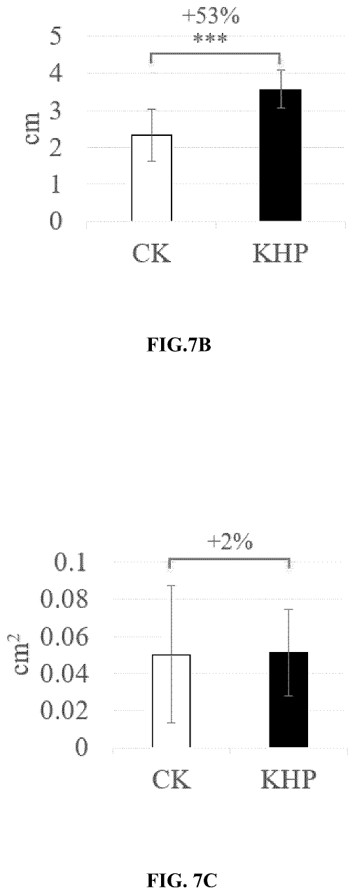

For the Lady Tomato plants tested above, on the fifth (5^{th}) day after the KHP solution's application, the comparisons are noted. FIG. 7A shows the above-ground fresh weights; FIG. 7B shows the plant heights; FIG. 7C shows the leaf surface area sizes.

As reflected in FIGS. 6 and 7, under the condition of soil with acidity value of pH5, the KHP groups boosted the Tsui-mei lettuce's growth by 89%, 44% and 284% (fresh weights, plant heights and leaf surface areas), and boosted the Lady tomato's growth by 195% and 53% (fresh weights and plant heights), though the leaf surface area's increase is a modest 2%.

From already known general researches, the inventors learned that extreme pH values would negatively impact plants' photosynthesis activities. The lower amount of chlorophyll is observed in Eucalyptus leaves under low pH value environment. It was noted that the chlorophyll a and chlorophyll b content in Arabidopsis plants have lower reading when grown in acidity of pH4.5 condition. The net photosynthetic rate and the actual quantum yield of the photosystem II (PSII) electron transport chain in walnut (Juglans regia L.) leaves are significantly reduced when grown in acidity of pH3.0 condition.

As such, the inventors went to test the effectiveness of KHP solutions to alleviate the interference to the photosynthesis caused by the acidity in soil condition. The inventors put 0.5 g leaf samples into 2 ml round bottom centrifuge tubes, and froze with liquid nitrogen; then using shakers to pulverize the leaves, and placed into 1 ml 80% ice acetone.

At 4° C., the leaf sample is subject to 8000 rpm centrifugal processing for 10 minutes. The upper clear liquids are retrieved and measurements were taken for the light absorption at 663.6, 646.6 and 470 nm, to calculate the content of chlorophyll a, chlorophyll b and carotenoid, based upon the formulas below:
[V: 80% acetone extracted liquid volume; W: leaf weight (g)]

$$Chlorophyll a ( mg / g ) = [ 12.5 \times ( A 663.6 ) - 2.55 \times ( A 646.6 ) ] \times V / ( 1000 \times W )$$

$$Chlorophyll b ( mg / g ) = [ 20.31 \times ( A 646.6 ) - 4.91 \times ( A 663.6 ) ] \times V / ( 1000 \times W )$$

$$Total Chlorophyll ( mg / g ) = [ 17.76 \times ( A 646.6 ) - 7.34 \times ( A 663.6 ) ] \times V / ( 1000 \times W )$$

$$Carotenoid ( mg / g ) = [ 1000 \times ( A 470 ) - 3.27 \times ( Chlorophyll a ) - 104 \times ( Chlorophyll b ) ] / 227 \times V / ( 1000 \times W )$$

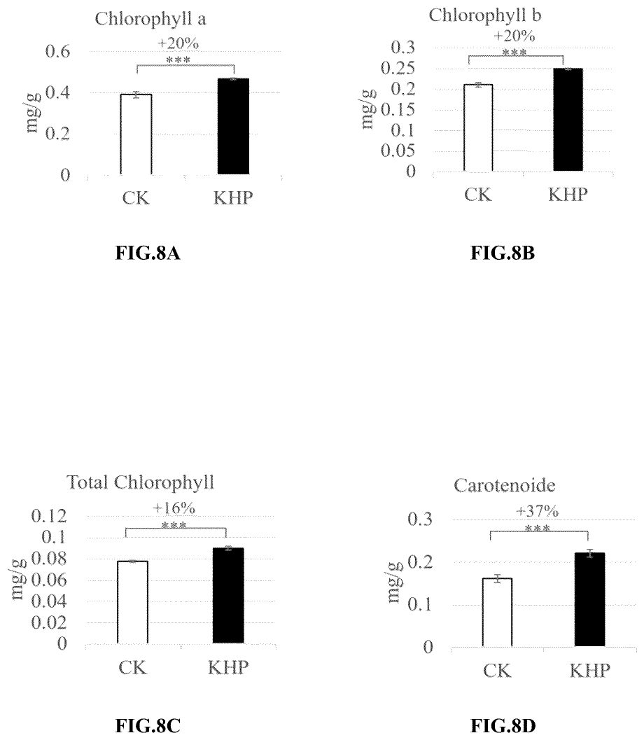

For the Tsui-mei lettuce tested above, on the fifth (5^{th}) day after the KHP solution's application, the inventors measured and tabulated the amount of photosynthetic pigments. FIG. 8A shows the amounts of the Chlorophyll a for the CK and KHP groups; FIG. 8B shows the amount s of the Chlorophyll b for the CK and KHP groups; FIG. 8C shows the total amounts of Chlorophyll for the CK and KHP groups FIG. 8D shows the total amounts of carotenoid for the CK and KHP groups. All four figures show substantial increase when the lettuce, in an acid environment, was treated with KHP solution.

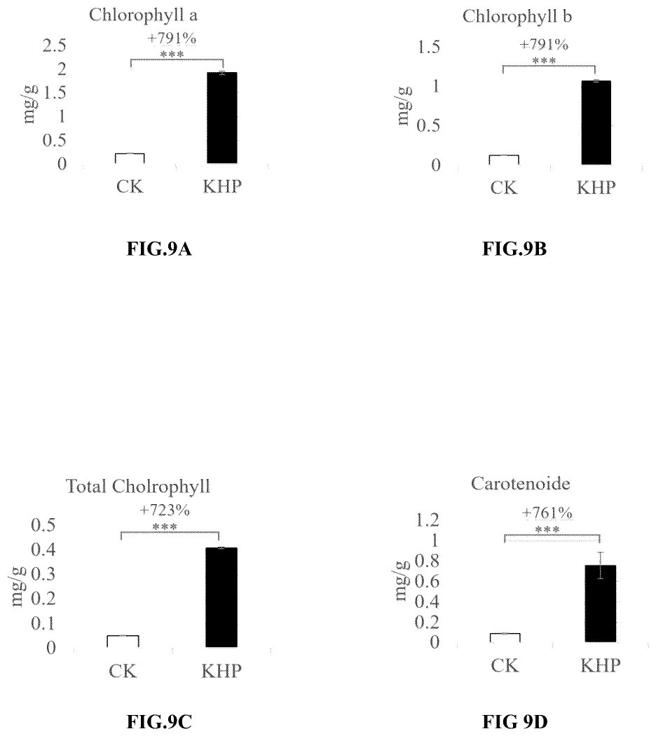

For the Lady Tomato tested above, on the fifth (5^{th}) day after the KHP solution's application, inventors measured and tabulated the amounts of photosynthetic pigments. FIG. 9A shows the amounts of the Chlorophyll a for the CK and KHP groups; FIG. 9B shows the amount s of the Chlorophyll b for the CK and KHP groups; FIG. 9C shows the total amounts of Chlorophyll for the CK and KHP groups FIG. 9D shows the total amounts of carotenoid for the CK and KHP groups. All four figures show more than 700% increase when the tomato, in an acid environment, was treated with KHP solution.

As reflected in FIGS. 8 and 9, the KHP groups of lettuce and tomato plants show increase of 20%, 20%, 16% and 37% (FIGS. 8A-8D) in the amount of Chlorophyll a, Chlorophyll b, total Chlorophyll and carotenoid over that of those measured from lettuce grown in acid soil, and increase of 791%, 791%, 723% and 761% over that of those measured from tomato plants grown in acid soil.

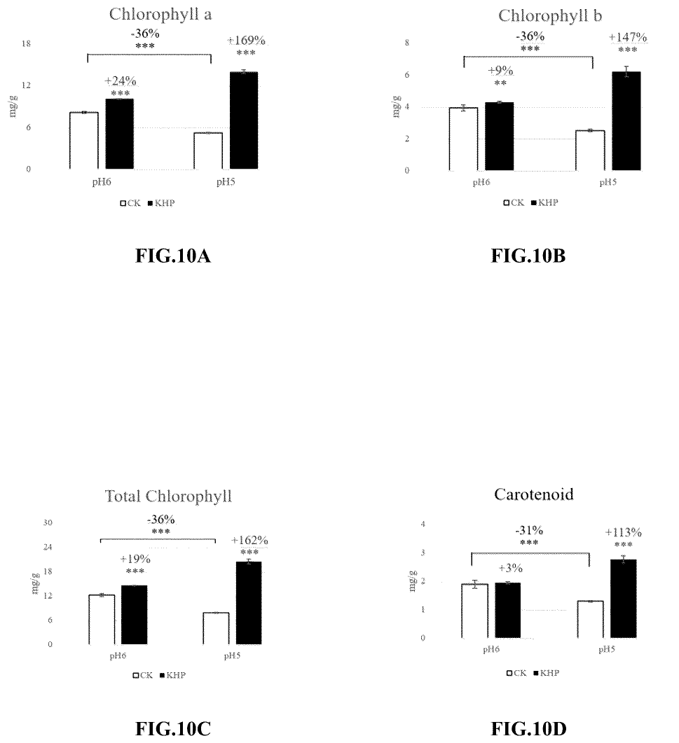

For the young corn plants tested above, on the third (3^{rd}) day after the KHP solution's application, inventors measured and tabulated the amounts of photosynthetic pigments. FIG. 10A shows the amounts of the Chlorophyll a for the CK and KHP groups; FIG. 10B shows the amount s of the Chlorophyll b for the CK and KHP groups; FIG. 10C shows the total amounts of Chlorophyll for the CK and KHP groups FIG. 10D shows the total amounts of carotenoid for the CK and KHP groups. The KHP solution's boost appear to be more obvious at a higher acidity level, at pH5 rather than pH6.

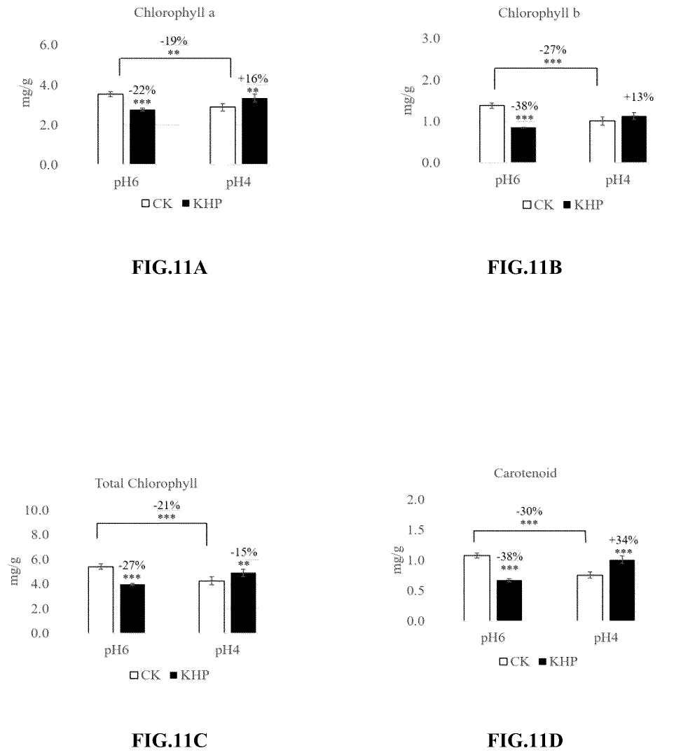

For the young soybean plants tested above, on the third (3^{rd}) day after the KHP solution's application, inventors measured and tabulated the amounts of photosynthetic pigments. FIG. 11A shows the amounts of the Chlorophyll a for the CK and KHP groups; FIG. 11B shows the amount s of the Chlorophyll b for the CK and KHP groups; FIG. 11C shows the total amounts of Chlorophyll for the CK and KHP groups FIG. 11D shows the total amounts of carotenoid for the CK and KHP groups. All four figures show substantial increase in the groups aided by KHP solution when the plants are grown in the acid environment.

As shown in FIGS. 10-11, corn and soybean plants benefited from the application of KHP solution compared to the CK group when grown in acid environment. The increase in the photosynthesis measurements, chlorophyll a, chlorophyll b, total chlorophyll and carotenoid are, respectively, 169%, 147%, 162% and 113% for corn plants (FIGS. 10A-10D) and 16%, 13%, 15% and 34% for soybean plants (FIGS. 11A-11D).

The inventors applied the salicylic acid-sulfuric acid method to assess the nitrate concentration, by grinding 0.2 g leaf tissue into 200 μl germless water. The extract is given 15 minutes of 3000×g centrifugal treatment, then the upper clean liquid is retrieved for measurement. Because the amount of nitrate content is positively proportional to plants' ability to absorb nitrogen, the nitrate concentration measurement would reflect that growth index.

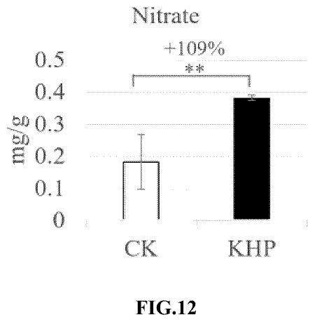

For the Tsui-mei lettuce planted in acid soil, on the fifth (5^{th}) day after the KHP solution's application, the inventors measured and tabulated the amount of nitrate. FIG. 12 shows that the KHP group, having be administered with 1.0 ml/L KHP solution, gains 109% of nitrate content over that of the CK group where the soil acidity is at pH5.

As has been proven by the tests conducted and verified via the scientific analysis/measurement done by the inventors, the method of creating the KHP solution and the method of application will help with the growth and root development of various farming plants when the acidity stress inhibits the normal growth and development of plants.

While the disclosure herein gave limited teachings and embodiment examples, it should be noted that the description and disclosure made herein illustrated the preferred embodiments of the invention and are not meant to limit the scope of the applicant's rights. Variations and alterations may be employed for yet additional embodiments without departing from the scope of the invention herein.

1. A method of using a keratin hydrolysis peptide (KHP) solution to promote the growth of farming plants under acidity stress, comprising the steps of:
a. Preparing the KHP solution by mixing 66 kg of feathers whose content is 50% water and 44 kg of water in a sealed container;
b. hydrolyzing the mixture in the container with a temperature and pressure setting of 195° C. and 16 kg/cm² for a duration of 40 minutes;
c. using a mass spectrometer to confirm the combination of peptides in the solution to contain at least 253 peptides as listed in the specification where their molecular masses are between 500 and 4,000 Daltons, and the concentration is in the range of 2.0×10⁵˜4.5×10⁵ ppm; and
d. Apply to water or soil wherein intended farming plants are grown.

2. The method of using a keratin hydrolysis peptide solution of claim 1 wherein the application to water for growing farming plants are done at a solution concentration of between 0.001 ml/L and 0.10 ml/L.

3. The method of using a keratin hydrolysis peptide solution of claim 1 wherein the application to soil for growing farming plants is done with the KHP solution diluted at the ratio of 1:50-2,000.

4. The method of using a keratin hydrolysis peptide solution of claim 3, wherein the preferred dilution ratio is 1:100-1,000.


SEQUENCE LISTING (253 sequences)

SEQ ID NO: 1 - protein, 6 aa, Gallus gallus
FGLSGL

SEQ ID NO: 2 - protein, 7 aa, Gallus gallus
AAVGSSL

SEQ ID NO: 3 - protein, 7 aa, Gallus gallus
TAVGSST

SEQ ID NO: 4 - protein, 6 aa, Gallus gallus
LSLSSQ

SEQ ID NO: 5 - protein, 7 aa, Gallus gallus
FGISGLG

SEQ ID NO: 6 - protein, 6 aa, Gallus gallus
PILSSF

SEQ ID NO: 7 - protein, 7 aa, Gallus gallus
SLLSQGA

SEQ ID NO: 8 - protein, 6 aa, Gallus gallus
FNLRGA

SEQ ID NO: 9 - protein, 8 aa, Gallus gallus
SAAVGSSL

SEQ ID NO: 10 - protein, 6 aa, Gallus gallus
SRVVIQ

SEQ ID NO: 11 - protein, 6 aa, Gallus gallus
SRVVLE

SEQ ID NO: 12 - protein, 8 aa, Gallus gallus
GFGISGLG

SEQ ID NO: 13 - protein, 6 aa, Gallus gallus
SRFSGR

SEQ ID NO: 14 - protein, 6 aa, Gallus gallus
RVVIQP

SEQ ID NO: 15 - protein, 8 aa, Gallus gallus
SAAVGSIL

SEQ ID NO: 16 - protein, 7 aa, Gallus gallus
IVVIGHV

SEQ ID NO: 17 - protein, 9 aa, Gallus gallus
TAVGSSTSA

SEQ ID NO: 18 - protein, 7 aa, Gallus gallus
RVVIQPS

SEQ ID NO: 19 - protein, 7 aa, Gallus gallus
SRVVIQP

SEQ ID NO: 20 - protein, 7 aa, Gallus gallus
PQGEQLQ

SEQ ID NO: 21 - protein, 9 aa, Gallus gallus
RAGAGPPSP

SEQ ID NO: 22 - protein, 7 aa, Gallus gallus
DSRVVIQ

SEQ ID NO: 23 - protein, 8 aa, Gallus gallus
PGPILSSF

SEQ ID NO: 24 - protein, 9 aa, Gallus gallus
PISSGGFGI

SEQ ID NO: 25 - protein, 8 aa, Gallus gallus
ISGLGSRF

SEQ ID NO: 26 - protein, 10 aa, Gallus gallus
SGGFGISGLG

SEQ ID NO: 27 - protein, 7 aa, Gallus gallus
SRFSGRR

SEQ ID NO: 28 - protein, 9 aa, Gallus gallus
PGLALPVLP

SEQ ID NO: 29 - protein, 8 aa, Gallus gallus
SRVVIQPS

SEQ ID NO: 30 - protein, 8 aa, Gallus gallus
PILSSFPQ

SEQ ID NO: 31 - protein, 8 aa, Gallus gallus
LGSGIFWI

SEQ ID NO: 32 - protein, 9 aa, Gallus gallus
GISGLGSRF

SEQ ID NO: 33 - protein, 9 aa, Gallus gallus
VVVTLPGPI

SEQ ID NO: 34 - protein, 8 aa, Gallus gallus
CRLSLSQP

SEQ ID NO: 35 - protein, 11 aa, Gallus gallus
SAAVGSSLSAG

SEQ ID NO: 36 - protein, 11 aa, Gallus gallus
AVGSSTSAAVG

SEQ ID NO: 37 - protein, 9 aa, Gallus gallus
VVTLPGPIL

SEQ ID NO: 38 - protein, 9 aa, Gallus gallus
PGPILSSFP

SEQ ID NO: 39 - protein, 10 aa, Gallus gallus
SAAVGSILSE

SEQ ID NO: 40 - protein, 10 aa, Gallus gallus
VPISSGGFGI

SEQ ID NO: 41 - protein, 8 aa, Gallus gallus
QLAQRNTI

SEQ ID NO: 42 - protein, 9 aa, Gallus gallus
LSGLRSNLS

SEQ ID NO: 43 - protein, 10 aa, Gallus gallus
PSPVVVTLPG

SEQ ID NO: 44 - protein, 10 aa, Gallus gallus
PPPVVVTLPG

SEQ ID NO: 45 - protein, 10 aa, Gallus gallus
ISGLGSRFSG

SEQ ID NO: 46 - protein, 9 aa, Gallus gallus
LALRQSVEA

SEQ ID NO: 47 - protein, 10 aa, Gallus gallus
PLLGPPLLGI

SEQ ID NO: 48 - protein, 10 aa, Gallus gallus
VVTLPGPILS

SEQ ID NO: 49 - protein, 8 aa, Gallus gallus
VTLEDLRR

SEQ ID NO: 50 - protein, 9 aa, Gallus gallus
PILSSFPQN

SEQ ID NO: 51 - protein, 9 aa, Gallus gallus
PILSSFPQD

SEQ ID NO: 52 - protein, 11 aa, Gallus gallus
GTVGVSAGVTR

SEQ ID NO: 53 - protein, 9 aa, Gallus gallus
FGLSRVTLN

SEQ ID NO: 54 - protein, 12 aa, Gallus gallus
TAVGSSTSAAVG

SEQ ID NO: 55 - protein, 10 aa, Gallus gallus
VVVTLPGPIL

SEQ ID NO: 56 - protein, 10 aa, Gallus gallus
PPVVVTFPGP

SEQ ID NO: 57 - protein, 10 aa, Gallus gallus
PPPVVVTFPG

SEQ ID NO: 58 - protein, 10 aa, Gallus gallus
VVIQPSPVVV

SEQ ID NO: 59 - protein, 10 aa, Gallus gallus
FGISGLGSRF

SEQ ID NO: 60 - protein, 10 aa, Gallus gallus
PGPILSSFPQ

SEQ ID NO: 61 - protein, 10 aa, Gallus gallus
FGWSGLGRGL

SEQ ID NO: 62 - protein, 9 aa, Gallus gallus
LEAQLSELR

SEQ ID NO: 63 - protein, 9 aa, Gallus gallus
IVGAWYTVR

SEQ ID NO: 64 - protein, 11 aa, Gallus gallus
LLSPPGLPGLL

SEQ ID NO: 65 - protein, 11 aa, Gallus gallus
VVVTLPGPILS

SEQ ID NO: 66 - protein, 11 aa, Gallus gallus
GFGISGLGSRF

SEQ ID NO: 67 - protein, 11 aa, Gallus gallus
PVVVTLPGPIL

SEQ ID NO: 68 - protein, 11 aa, Gallus gallus
VSQGEITVPSI

SEQ ID NO: 69 - protein, 11 aa, Gallus gallus
SILSEEGVPIS

SEQ ID NO: 70 - protein, 11 aa, Gallus gallus
PVVVTFPGPIL

SEQ ID NO: 71 - protein, 13 aa, Gallus gallus
PISSGGFGISGLG

SEQ ID NO: 72 - protein, 13 aa, Gallus gallus
VGSSTSAAVGSIL

SEQ ID NO: 73 - protein, 11 aa, Gallus gallus
GFLSSAVSLNR

SEQ ID NO: 74 - protein, 12 aa, Gallus gallus
GGFGISGLGSRF

SEQ ID NO: 75 - protein, 11 aa, Gallus gallus
PGPILSSFPQN

SEQ ID NO: 76 - protein, 11 aa, Gallus gallus
PGPILSSFPQD

SEQ ID NO: 77 - protein, 12 aa, Gallus gallus
GGFGWSGLGRGL

SEQ ID NO: 78 - protein, 12 aa, Gallus gallus
PSPVVVTLPGPI

SEQ ID NO: 79 - protein, 12 aa, Gallus gallus
VVVTLPGPILSS

SEQ ID NO: 80 - protein, 12 aa, Gallus gallus
PVVVTLPGPILS

SEQ ID NO: 81 - protein, 12 aa, Gallus gallus
SPVVVTLPGPIL

SEQ ID NO: 82 - protein, 11 aa, Gallus gallus
RVVIQPSPVVV

SEQ ID NO: 83 - protein, 11 aa, Gallus gallus
QALTEVYAKAN

SEQ ID NO: 84 - protein, 10 aa, Gallus gallus
IETLTQFLGW

SEQ ID NO: 85 - protein, 13 aa, Gallus gallus
GFGSRSLVGLGGT

SEQ ID NO: 86 - protein, 14 aa, Gallus gallus
AVGSSTSAAVGSIL

SEQ ID NO: 87 - protein, 12 aa, Gallus gallus
PVVVTFPGPILS

SEQ ID NO: 88 - protein, 14 aa, Gallus gallus
VGSSTSAAVGSILS

SEQ ID NO: 89 - protein, 13 aa, Gallus gallus
GFGISGLGSRFSG

SEQ ID NO: 90 - protein, 13 aa, Gallus gallus
SGGFGISGLGSRF

SEQ ID NO: 91 - protein, 14 aa, Gallus gallus
VPISSGGFGISGLG

SEQ ID NO: 92 - protein, 12 aa, Gallus gallus
VVIQPSPVVVTL

SEQ ID NO: 93 - protein, 13 aa, Gallus gallus
SILSEEGVPISSG

SEQ ID NO: 94 - protein, 13 aa, Gallus gallus
VMGCKAAGASRII

SEQ ID NO: 95 - protein, 13 aa, Gallus gallus
SPVVVTLPGPILS

SEQ ID NO: 96 - protein, 12 aa, Gallus gallus
SRVVIQPSPVVV

SEQ ID NO: 97 - protein, 13 aa, Gallus gallus
PSPVVVTLPGPIL

SEQ ID NO: 98 - protein, 12 aa, Gallus gallus
RVVIQPSPVVVT

SEQ ID NO: 99 - protein, 13 aa, Gallus gallus
PPPVVVTLPGPIL

SEQ ID NO: 100 - protein, 15 aa, Gallus gallus
GVPISSGGFGISGLG

SEQ ID NO: 101 - protein, 13 aa, Gallus gallus
VIQPSPVVVTLPG

SEQ ID NO: 102 - protein, 15 aa, Gallus gallus
AVGSSTSAAVGSILS

SEQ ID NO: 103 - protein, 15 aa, Gallus gallus
TAVGSSTSAAVGSIL

SEQ ID NO: 104 - protein, 14 aa, Gallus gallus
SGGFGISGLGSRFS

SEQ ID NO: 105 - protein, 13 aa, Gallus gallus
VVVTLPGPILSSF

SEQ ID NO: 106 - protein, 13 aa, Gallus gallus
PPPVVVTFPGPIL

SEQ ID NO: 107 - protein, 14 aa, Gallus gallus
GLGGFGWSGLGRGL

SEQ ID NO: 108 - protein, 13 aa, Gallus gallus
VTLPGPILSSFPQ

SEQ ID NO: 109 - protein, 14 aa, Gallus gallus
AVGSILSEEGVPIS

SEQ ID NO: 110 - protein, 14 aa, Gallus gallus
SLGLGGFGWSGLGR

SEQ ID NO: 111 - protein, 14 aa, Gallus gallus
PSPVVVTLPGPILS

SEQ ID NO: 112 - protein, 13 aa, Gallus gallus
SRVVIQPSPVVVT

SEQ ID NO: 113 - protein, 15 aa, Gallus gallus
SGGFGISGLGSRFSG

SEQ ID NO: 114 - protein, 14 aa, Gallus gallus
PPPVVVTLPGPILS

SEQ ID NO: 115 - protein, 14 aa, Gallus gallus
VAIQPPPVVVTLPG

SEQ ID NO: 116 - protein, 15 aa, Gallus gallus
PISSGGFGISGLGSR

SEQ ID NO: 117 - protein, 13 aa, Gallus gallus
PIVDVAEALLHVK

SEQ ID NO: 118 - protein, 14 aa, Gallus gallus
VVIQPSPVVVTLPG

SEQ ID NO: 119 - protein, 13 aa, Gallus gallus
RVVIQPSPVVVTL

SEQ ID NO: 120 - protein, 16 aa, Gallus gallus
TAVGSSTSAAVGSILS

SEQ ID NO: 121 - protein, 14 aa, Gallus gallus
PPPVVVTFPGPILS

SEQ ID NO: 122 - protein, 15 aa, Gallus gallus
SLGLGGFGWSGLGRG

SEQ ID NO: 123 - protein, 14 aa, Gallus gallus
VVVTLPGPILSSFP

SEQ ID NO: 124 - protein, 14 aa, Gallus gallus
PVVVTLPGPILSSF

SEQ ID NO: 125 - protein, 15 aa, Gallus gallus
AAVGSILSEEGVPIS

SEQ ID NO: 126 - protein, 15 aa, Gallus gallus
SAAVGSILSEEGVPI

SEQ ID NO: 127 - protein, 16 aa, Gallus gallus
EGVPISSGGFGISGLG

SEQ ID NO: 128 - protein, 14 aa, Gallus gallus
VVTLPGPILSSFPQ

SEQ ID NO: 129 - protein, 15 aa, Gallus gallus
PSPVVVTLPGPILSS

SEQ ID NO: 130 - protein, 16 aa, Gallus gallus
GKDGPKGVRGDAGPPG

SEQ ID NO: 131 - protein, 15 aa, Gallus gallus
SVAIQPPPVVVTLPG

SEQ ID NO: 132 - protein, 14 aa, Gallus gallus
SRVVIQPSPVVVTL

SEQ ID NO: 133 - protein, 14 aa, Gallus gallus
LHTEAAATVPDRSE

SEQ ID NO: 134 - protein, 15 aa, Gallus gallus
VVIQPSPVVVTLPGP

SEQ ID NO: 135 - protein, 14 aa, Gallus gallus
RVVIQPSPVVVTLP

SEQ ID NO: 136 - protein, 16 aa, Gallus gallus
SAAVGSILSEEGVPIS

SEQ ID NO: 137 - protein, 15 aa, Gallus gallus
PVVVTLPGPILSSFP

SEQ ID NO: 138 - protein, 15 aa, Gallus gallus
IQPSPVVVTLPGPIL

SEQ ID NO: 139 - protein, 17 aa, Gallus gallus
SVPIGAGGSLGLGGFGW

SEQ ID NO: 140 - protein, 16 aa, Gallus gallus
SLGLGGFGWSGLGRGL

SEQ ID NO: 141 - protein, 17 aa, Gallus gallus
FGGGFGGGDGILPAGEK

SEQ ID NO: 142 - protein, 17 aa, Gallus gallus
TAVGSSTSAAVGSILSE

SEQ ID NO: 143 - protein, 16 aa, Gallus gallus
PISSGGFGISGLGSRF

SEQ ID NO: 144 - protein, 19 aa, Gallus gallus
SAAVGSSLSAGSVPIGAGG

SEQ ID NO: 145 - protein, 17 aa, Gallus gallus
GVPISSGGFGISGLGSR

SEQ ID NO: 146 - protein, 15 aa, Gallus gallus
VVVTLPGPILSSFPQ

SEQ ID NO: 147 - protein, 15 aa, Gallus gallus
RVVIQPSPVVVTLPG

SEQ ID NO: 148 - protein, 15 aa, Gallus gallus
SRVVIQPSPVVVTLP

SEQ ID NO: 149 - protein, 16 aa, Gallus gallus
PSPVVVTLPGPILSSF

SEQ ID NO: 150 - protein, 16 aa, Gallus gallus
AIQPPPVVVTLPGPIL

SEQ ID NO: 151 - protein, 16 aa, Gallus gallus
IQPSPVVVTLPGPILS

SEQ ID NO: 152 - protein, 16 aa, Gallus gallus
VIQPSPVVVTLPGPIL

SEQ ID NO: 153 - protein, 17 aa, Gallus gallus
VPISSGGFGISGLGSRF

SEQ ID NO: 154 - protein, 16 aa, Gallus gallus
SRVVIQPSPVVVTLPG

SEQ ID NO: 155 - protein, 17 aa, Gallus gallus
SILSEEGVPISSGGFGI

SEQ ID NO: 156 - protein, 16 aa, Gallus gallus
PVVVTLPGPILSSFPQ

SEQ ID NO: 157 - protein, 16 aa, Gallus gallus
RVVIQPSPVVVTLPGP

SEQ ID NO: 158 - protein, 18 aa, Gallus gallus
SAAVGSILSEEGVPISSG

SEQ ID NO: 159 - protein, 16 aa, Gallus gallus
VVVTLPGPILSSFPQN

SEQ ID NO: 160 - protein, 18 aa, Gallus gallus
GVPISSGGFGISGLGSRF

SEQ ID NO: 161 - protein, 17 aa, Gallus gallus
PSPVVVTLPGPILSSFP

SEQ ID NO: 162 - protein, 17 aa, Gallus gallus
VAIQPPPVVVTLPGPIL

SEQ ID NO: 163 - protein, 17 aa, Gallus gallus
VIQPSPVVVTLPGPILS

SEQ ID NO: 164 - protein, 17 aa, Gallus gallus
VVIQPSPVVVTLPGPIL

SEQ ID NO: 165 - protein, 17 aa, Gallus gallus
SPVVVTLPGPILSSFPQ

SEQ ID NO: 166 - protein, 15 aa, Gallus gallus
VILSNTKTQYSIKIH

SEQ ID NO: 167 - protein, 17 aa, Gallus gallus
SRVVIQPSPVVVTLPGP

SEQ ID NO: 168 - protein, 17 aa, Gallus gallus
DSRVVIQPSPVVVTLPG

SEQ ID NO: 169 - protein, 17 aa, Gallus gallus
PVVVTLPGPILSSFPQN

SEQ ID NO: 170 - protein, 17 aa, Gallus gallus
RVVIQPSPVVVTLPGPI

SEQ ID NO: 171 - protein, 19 aa, Gallus gallus
GVPISSGGFGISGLGSRFS

SEQ ID NO: 172 - protein, 18 aa, Gallus gallus
SVAIQPPPVVVTLPGPIL

SEQ ID NO: 173 - protein, 18 aa, Gallus gallus
VAIQPPPVVVTLPGPILS

SEQ ID NO: 174 - protein, 18 aa, Gallus gallus
VVIQPSPVVVTLPGPILS

SEQ ID NO: 175 - protein, 18 aa, Gallus gallus
PSPVVVTLPGPILSSFPQ

SEQ ID NO: 176 - protein, 20 aa, Gallus gallus
GVPISSGGFGISGLGSRFSG

SEQ ID NO: 177 - protein, 18 aa, Gallus gallus
AVPLVRPVTMVPSIPGIP

SEQ ID NO: 178 - protein, 18 aa, Gallus gallus
PPPVVVTLPGPILSSFPQ

SEQ ID NO: 179 - protein, 18 aa, Gallus gallus
SPVVVTLPGPILSSFPQN

SEQ ID NO: 180 - protein, 18 aa, Gallus gallus
LPGPGLQLLHGTTTLAFK

SEQ ID NO: 181 - protein, 18 aa, Gallus gallus
PPPVVVTFPGPILSSFPQ

SEQ ID NO: 182 - protein, 19 aa, Gallus gallus
SVAIQPPPVVVTLPGPILS

SEQ ID NO: 183 - protein, 19 aa, Gallus gallus
SSVAIQPPPVVVTLPGPIL

SEQ ID NO: 184 - protein, 18 aa, Gallus gallus
RVVIQPSPVVVTLPGPIL

SEQ ID NO: 185 - protein, 19 aa, Gallus gallus
PSPVVVTLPGPILSSFPQN

SEQ ID NO: 186 - protein, 21 aa, Gallus gallus
SILSEEGVPISSGGFGISGLG

SEQ ID NO: 187 - protein, 19 aa, Gallus gallus
SRVVIQPSPVVVTLPGPIL

SEQ ID NO: 188 - protein, 19 aa, Gallus gallus
RVVIQPSPVVVTLPGPILS

SEQ ID NO: 189 - protein, 22 aa, Gallus gallus
SVPIGAGGSLGLGGFGWSGLGR

SEQ ID NO: 190 - protein, 22 aa, Gallus gallus
TAVGSSTSAAVGSILSEEGVPI

SEQ ID NO: 191 - protein, 22 aa, Gallus gallus
SAAVGSILSEEGVPISSGGFGI

SEQ ID NO: 192 - protein, 21 aa, Gallus gallus
SEEGVPISSGGFGISGLGSRF

SEQ ID NO: 193 - protein, 20 aa, Gallus gallus
SRVVIQPSPVVVTLPGPILS

SEQ ID NO: 194 - protein, 23 aa, Gallus gallus
SVPIGAGGSLGLGGFGWSGLGRG

SEQ ID NO: 195 - protein, 20 aa, Gallus gallus
DSRVVIQPSPVVVTLPGPIL

SEQ ID NO: 196 - protein, 23 aa, Gallus gallus
TAVGSSTSAAVGSILSEEGVPIS

SEQ ID NO: 197 - protein, 22 aa, Gallus gallus
LRGDVGPVGRTGEQGIAGPPGF

SEQ ID NO: 198 - protein, 21 aa, Gallus gallus
SRVVIQPSPVVVTLPGPILSS

SEQ ID NO: 199 - protein, 21 aa, Gallus gallus
VVIQPSPVVVTLPGPILSSFP

SEQ ID NO: 200 - protein, 22 aa, Gallus gallus
GVPISSGGFGISGLGSRFSGRR

SEQ ID NO: 201 - protein, 24 aa, Gallus gallus
SVPIGAGGSLGLGGFGWSGLGRGL

SEQ ID NO: 202 - protein, 21 aa, Gallus gallus
DSRVVIQPSPVVVTLPGPILS

SEQ ID NO: 203 - protein, 21 aa, Gallus gallus
VIQPSPVVVTLPGPILSSFPQ

SEQ ID NO: 204 - protein, 24 aa, Gallus gallus
AVGSILSEEGVPISSGGFGISGLG

SEQ ID NO: 205 - protein, 21 aa, Gallus gallus
RVVIQPSPVVVTLPGPILSSF

SEQ ID NO: 206 - protein, 23 aa, Gallus gallus
SILSEEGVPISSGGFGISGLGSR

SEQ ID NO: 207 - protein, 21 aa, Gallus gallus
IPSSVPESSFKIKGNSSSFHI

SEQ ID NO: 208 - protein, 22 aa, Gallus gallus
VAIQPPPVVVTLPGPILSSFPQ

SEQ ID NO: 209 - protein, 25 aa, Gallus gallus
TAVGSSTSAAVGSILSEEGVPISSG

SEQ ID NO: 210 - protein, 22 aa, Gallus gallus
VVIQPSPVVVTLPGPILSSFPQ

SEQ ID NO: 211 - protein, 23 aa, Gallus gallus
PSPVVVTLPGPILSSFPQNTAVG

SEQ ID NO: 212 - protein, 20 aa, Gallus gallus
KENFEVLCKDGTRKPVTDAE

SEQ ID NO: 213 - protein, 21 aa, Gallus gallus
SIQACKLAQSHGWGVMVSHRS

SEQ ID NO: 214 - protein, 22 aa, Gallus gallus
SRVVIQPSPVVVTLPGPILSSF

SEQ ID NO: 215 - protein, 22 aa, Gallus gallus
RVVIQPSPVVVTLPGPILSSFP

SEQ ID NO: 216 - protein, 23 aa, Gallus gallus
EQPPLCVASVSVKEPASETPAVP

SEQ ID NO: 217 - protein, 23 aa, Gallus gallus
SVAIQPPPVVVTLPGPILSSFPQ

SEQ ID NO: 218 - protein, 26 aa, Gallus gallus
SAAVGSILSEEGVPISSGGFGISGLG

SEQ ID NO: 219 - protein, 24 aa, Gallus gallus
SILSEEGVPISSGGFGISGLGSRF

SEQ ID NO: 220 - protein, 24 aa, Gallus gallus
PSPVVVTLPGPILSSFPQNTAVGS

SEQ ID NO: 221 - protein, 23 aa, Gallus gallus
VVIQPSPVVVTLPGPILSSFPQN

SEQ ID NO: 222 - protein, 23 aa, Gallus gallus
SRVVIQPSPVVVTLPGPILSSFP

SEQ ID NO: 223 - protein, 24 aa, Gallus gallus
SSVAIQPPPVVVTLPGPILSSFPQ

SEQ ID NO: 224 - protein, 23 aa, Gallus gallus
RVVIQPSPVVVTLPGPILSSFPQ

SEQ ID NO: 225 - protein, 25 aa, Gallus gallus
SILSEEGVPISSGGFGISGLGSRFS

SEQ ID NO: 226 - protein, 27 aa, Gallus gallus
TSAAVGSILSEEGVPISSGGFGISGLG

SEQ ID NO: 227 - protein, 26 aa, Gallus gallus
SILSEEGVPISSGGFGISGLGSRFSG

SEQ ID NO: 228 - protein, 24 aa, Gallus gallus
SRVVIQPSPVVVTLPGPILSSFPQ

SEQ ID NO: 229 - protein, 28 aa, Gallus gallus
TAVGSSTSAAVGSILSEEGVPISSGGFG

SEQ ID NO: 230 - protein, 28 aa, Gallus gallus
STSAAVGSILSEEGVPISSGGFGISGLG

SEQ ID NO: 231 - protein, 24 aa, Gallus gallus
RVVIQPSPVVVTLPGPILSSFPQN

SEQ ID NO: 232 - protein, 25 aa, Gallus gallus
SRVVIQPSPVVVTLPGPILSSFPQN

SEQ ID NO: 233 - protein, 25 aa, Gallus gallus
DSRVVIQPSPVVVTLPGPILSSFPQ

SEQ ID NO: 234 - protein, 29 aa, Gallus gallus
TAVGSSTSAAVGSILSEEGVPISSGGFGI

SEQ ID NO: 235 - protein, 29 aa, Gallus gallus
SAAVGSILSEEGVPISSGGFGISGLGSRF

SEQ ID NO: 236 - protein, 24 aa, Gallus gallus
VEQLVNLQHLDVAYNLLLEHAQLA

SEQ ID NO: 237 - protein, 28 aa, Gallus gallus
SVAIQPPPVVVTLPGPILSSFPQSTAVG

SEQ ID NO: 238 - protein, 28 aa, Gallus gallus
SILSEEGVPISSGGFGISGLGSRFSGRR

SEQ ID NO: 239 - protein, 30 aa, Gallus gallus
TSAAVGSILSEEGVPISSGGFGISGLGSRF

SEQ ID NO: 240 - protein, 29 aa, Gallus gallus
SSVAIQPPPVVVTLPGPILSSFPQSTAVG

SEQ ID NO: 241 - protein, 31 aa, Gallus gallus
STSAAVGSILSEEGVPISSGGFGISGLGSRF

SEQ ID NO: 242 - protein, 31 aa, Gallus gallus
PSPVVVTLPGPILSSFPQNTAVGSSTSAAVG

SEQ ID NO: 243 - protein, 33 aa, Gallus gallus
TAVGSSTSAAVGSILSEEGVPISSGGFGISGLG

SEQ ID NO: 244 - protein, 31 aa, Gallus gallus
AVGSILSEEGVPISSGGFGISGLGSRFSGRR

SEQ ID NO: 245 - protein, 27 aa, Gallus gallus
NKVLVHCAMGRSRSATLVLAYLMIYKN

SEQ ID NO: 246 - protein, 32 aa, Gallus gallus
SSVAIQPPPVVVTLPGPILSSFPQSTAVGSTA

SEQ ID NO: 247 - protein, 32 aa, Gallus gallus
AAVGSILSEEGVPISSGGFGISGLGSRFSGRR

SEQ ID NO: 248 - protein, 35 aa, Gallus gallus
TAVGSSTSAAVGSILSEEGVPISSGGFGISGLGSR

SEQ ID NO: 249 - protein, 33 aa, Gallus gallus
SAAVGSILSEEGVPISSGGFGISGLGSRFSGRR

SEQ ID NO: 250 - protein, 34 aa, Gallus gallus
PSPVVVTLPGPILSSFPQNTAVGSSTSAAVGSIL

SEQ ID NO: 251 - protein, 35 aa, Gallus gallus
PSPVVVTLPGPILSSFPQNTAVGSSTSAAVGSILS

SEQ ID NO: 252 - protein, 36 aa, Gallus gallus
TAVGSSTSAAVGSILSEEGVPISSGGFGISGLGSRF

SEQ ID NO: 253 - protein, 29 aa, Gallus gallus
RPRVYLHCTNPRHPKYREGDVTLFALNLS